(19) United States
(12) Patent Application Publication
(10) Pub. No.: US 2005/0071419 A1
(43) Pub. Date: Mar. 31, 2005

(54) System, apparatus, and method for providing Web services using wireless push

(76) Inventor: Stephen Paul Lewontin, Cambridge, MA (US)

Correspondence Address: Crawford Maunu PLLC, Suite 390, 1270 Northland Drive, St. Paul, MN, 55120, US

(21) Appl. No.: 10/672,299

(22) Filed: Sep. 26, 2003

(51) Int. Cl. G06F 15/16

(52) U.S. Cl. 709/201

(57) ABSTRACT

The present disclosure is directed to a system, apparatus, and method for providing Web services from a mobile device. In one arrangement, a mobile device is coupled to a server over a wireless network. The mobile device includes a Web services processing module and can receive a server-initiated data push. This data push can be implemented using a (WAP) Connection-Oriented (CO) Over the Air (OTA) push. A transport protocol can be bound to the data push, and a Web service message sent to the mobile device via the server initiated data push using the transport protocol. The mobile device can then process the Web service message and provide a response via the server initiated data push, if needed.

### FIELD OF THE INVENTION

This invention relates in general to Web services, and more particularly, to providing Web services on mobile devices.

### BACKGROUND OF THE INVENTION

Lately, the emergence of what are known as “Web services” have been used to extend the World Wide Web's capability by providing dynamic content that is programmatically accessible. Initially, content published on the Web was in the form of static pages that were downloaded to a browser. The browser interpreted the page for display, as well as handling user input to objects such as forms or buttons. Later adaptations to Web servers include providing dynamic content on demand, although this content was still intended for access by Web browsers.

Web services allow information to be accessed in other application domains besides browsers. Web services use the same open and extensible formats that have made Web browsers so useful. As a result, Web services can be powerful tools usable for providing distributed data access in many application domains.

Web services are network-based (particularly Internet-based) applications that perform a specific task and conform to a specific technical format. Web services are represented by a stack of emerging standards that describe a service-oriented, application architecture, collectively providing a distributed computing paradigm having a particular focus on delivering services across the Internet.

Generally, Web services are implemented as self-contained modular applications that can be published in a ready-to-use format, located, and invoked across the World Wide Web. When a Web service is deployed, other applications and Web services can locate and invoke the deployed service. They can perform a variety of functions, ranging from simple requests to complicated business processes.

Web services are typically configured to use standard Web protocols such as Hypertext Transfer Protocol (HTTP), Extensible Markup Language (XML) and Simplified Object Access Protocol (SOAP). HTTP is an application-level protocol commonly used to transport data on the Web. XML is a mechanism to define markup languages. Some markup languages (e.g. XHTML) are used mainly to describe how a document is to be formatted for display. Others, such as SOAP, are used to describe data. SOAP is a markup language for message encapsulation and is typically used to transmit messages that invoke remote procedure calls, return the results from such invocation, or to transmit documents.

Web services are typically available on Internet servers. Because servers are typically set up to listen for incoming HTTP connections, the servers are easily adapted to listen for and process Web service requests. Servers are typically accessed by a well known identifier, such as a Uniform Resource Locator (URL) that may contain a hostname or Internet Protocol (IP) address. To invoke a Web service, a client needs to know the identifier, the Web service protocol supported by the server (e.g., SOAP), and the procedure to be invoked.

In the standard SOAP-HTTP binding, a SOAP messaging transaction is carried out over a TCP connection from the client to a Web server. When the transaction is carried out over the Internet, the server has an IP address used for sending data to the server. The network routes connection requests to the server, which is setup to accept these requests. The server may have a process running to handle the request, or the server may be configured to start a server process to handle the connection.

Although SOAP and other Web services are usually provided by a dedicated server, any device having an accessible IP address may act as a Web services server. Devices characterized as client machines traditionally have not been configured to accept incoming connections, although such client-side services are becoming more prevalent due to popular applications such as instant messaging and file sharing. Providing client-side services still requires that the client have an accessible identifier such as a hostname and/or IP address, as well as the infrastructure to locate the client and route requests to the client's IP address.

Certain devices such as mobile terminals may not have an easily accessible identifier for Internet services. While it is possible to support the client side of Web services on mobile terminals, supporting server functionality on mobile terminals is more difficult.

In most cases, it is not possible to directly initiate a connection from an arbitrary network entity to a mobile terminal to invoke a service on the mobile terminal. In mobile operator infrastructures, terminals are not typically IP addressable. It also may be relatively costly to implement an “always on” service to handle connection requests on a small, low powered device. However, numerous benefits may be realized from providing services on mobile devices, since these devices can provide immediate and continuous access to users. As mobile device become more sophisticated and ubiquitous, providing a way of serving Web services and related content from mobile terminals will be become more important.

### SUMMARY OF THE INVENTION

The present disclosure relates to a system, apparatus, and method for providing Web services using wireless push. In accordance with one embodiment of the present invention, a method involves forming a Web service message at a first network entity. The Web service message is targeted for a second network entity. A server-initiated wireless push session is established with the second network entity. A transport protocol is bound with the server-initiated wireless push session. The Web service message is sent to the second network entity using the transport protocol, and the Web service message is processed at the second network entity.

Processing the Web service message at the second network entity may involve forming a Web service response message targeted for the first network entity. The Web service message may include a SOAP message. The transport protocol may include any of HTTP and WSP. The server initiated push session includes a WAP OTA push.

In another embodiment of the present invention, a system for providing Web services from a mobile terminal includes means for receiving a Web service request message via a network. The system includes means for transmitting the Web service request message via a server-initiated wireless push session, means for receiving the Web service request message at the mobile terminal via the server-initiated wireless push session, and means for processing the Web service request message at the mobile terminal.

In another embodiment of the present invention, a mobile terminal is wirelessly coupled to a network. The mobile terminal includes a transceiver configured to facilitate exchange of data with the network via a server-initiated wireless push session. The terminal includes a memory capable of storing at least one of a data transfer module and a Web services processing module. A processor is coupled to the memory and the transceiver. The processor is configured by the data transfer module to receive Web service messages targeted for the mobile terminal via the server-initiated wireless push session and communicate the Web service messages to the Web services processing module. The processor is configured by the Web services processing module to process the Web service messages.

In another embodiment of the present invention, a server is coupled to a network and facilitates communications with a wireless terminal. The server includes means for receiving Web service messages targeted for the wireless terminal via the network, means for initiating a server-initiated push session with the wireless terminal, and means for sending the Web service messages to the wireless terminals via the server-initiated push session.

### BRIEF DESCRIPTION OF THE DRAWINGS

FIG. 1 illustrates a system environment in which Web services provided from mobile terminals may be employed according to embodiments of the present invention;

FIG. 2 illustrates an example computing arrangement for providing Web services using WAP OTA Push according to embodiments of the present invention;

FIG. 3 is a sequence diagram illustrating a SOAP message exchange using WAP OTA Push bound to HTTP according to embodiments of the present invention;

FIG. 4 is a sequence diagram illustrating a SOAP message exchange using WAP OTA Push bound to WSP according to embodiments of the present invention;

FIG. 5 is a flowchart illustrating processing of a SOAP message received using WAP OTA Push on a wireless terminal according to embodiment of the present invention;

FIG. 6 is a flowchart illustrating the sending of SOAP messages from a server to a wireless terminal using WAP OTA Push according to embodiment of the present invention;

FIG. 7 illustrates a computing arrangement for processing of Web service messages according to embodiments of the present invention; and

FIG. 8 illustrates a mobile terminal for processing of Web service messages according to embodiments of the present invention.

### DETAILED DESCRIPTION OF THE INVENTION

In the following description of the example embodiments, reference is made to the accompanying drawings which form a part hereof, and in which is shown by way of illustration various example embodiments in which the invention may be practiced. It is to be understood that other embodiments may be utilized, as structural and operational changes may be made without departing from the scope of the present invention.

Generally, the present disclosure is directed to a system, apparatus, and method for providing Web services from a mobile device. In one arrangement, a mobile device is coupled to a server over a wireless network. The mobile device includes a Web services processing stack and can receive a server-initiated, asynchronous data push. This data push can be implemented using a technology such as a Wireless Application Protocol (WAP) connection-oriented Over the Air (OTA) push. A transport protocol can be bound to the data push, and a Web service message sent to the mobile device using the transport protocol. The mobile device can then process the Web service message and provide a response, if needed.

The concepts of processing Web service messages may be described herein using specific examples of networking technologies. For example, the Web service message exchanges may be shown using the Simple Object Access Protocol (SOAP). Those skilled in the art will appreciate that the concepts described using example SOAP messaging and processing arrangements are equally applicable to other Web service technologies and protocols, such as XML-Remote Procedure Call (XML-RPC), Java, ActiveX, etc. Similarly, examples of server-initiated, data push connections may be described as WAP OTA push connections. It will be appreciated that descriptions related to WAP OTA push are applicable to any similar current or future technology for initiating data sessions with mobile data devices.

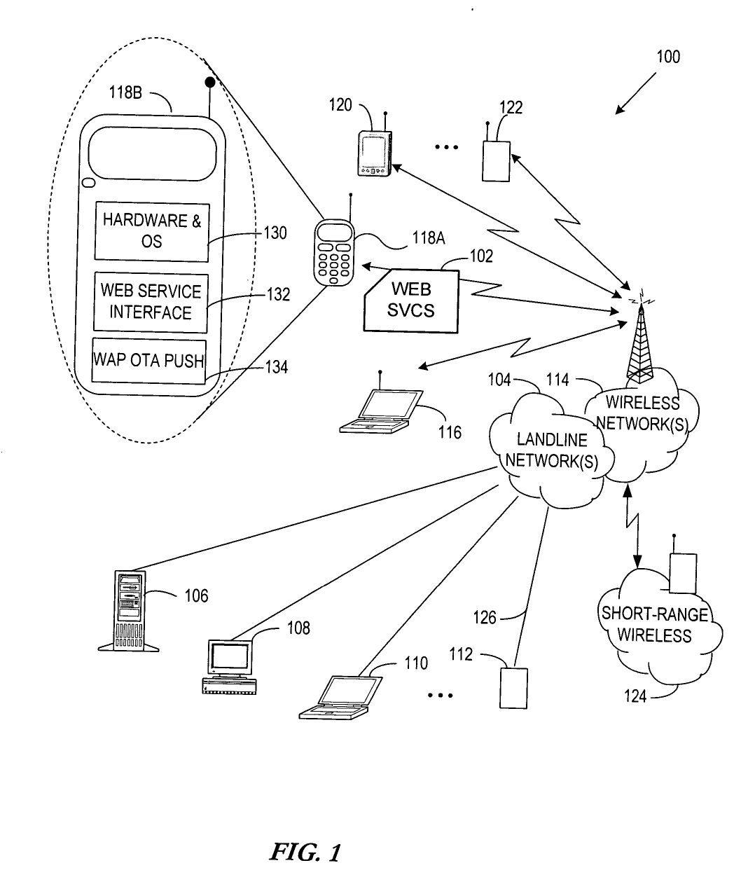

Referring now to FIG. 1, a representative system environment 100 is illustrated in which Web services may be employed according to embodiments of the present invention. In the representative system environment 100, Web services messages 102 may be communicated using a wireless push protocol between target devices in any combination of known manners. These manners include via a landline network(s) 104, which may include a Global Area Network (GAN) such as the Internet, one or more Wide Area Networks (WAN), Local Area Networks (LAN), and the like. Any computing device or other electronic device that supports Web services may interact with arrangements according the present invention, such as servers 106, desktop computers 108 or workstations, laptop or other portable computers 110, or any other similar computing device capable of communicating via the network 104, as represented by generic device 112.

The Web services may be communicated via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device can provide Web services initiated with a wireless push protocol, such as laptop or other portable computers 116, mobile phones 118A and other mobile communicators, Personal Digital Assistants (PDA) 120, or any other similar computing device capable of communicating via the wireless network 114, as represented by generic device 122.

The Web service message 102 may also be transferred between devices using short-range wireless technologies 124, such as Bluetooth, Wireless Local Area Network (WLAN), infrared (IR), etc. The message 102 can additionally be distributed using direct wired connections, such as depicted by connection path 126. The present invention is applicable regardless of the manner in which data is provided or distributed across the system environment 100.

An example of a target device that provides Web services is illustrated as the mobile phone 118B. The mobile phone 118B includes, for example, hardware (including the processor) coupled to an operating system (OS) 130. A Web services module 132 can be configured to receive incoming Web service requests, such as the Web service message 102. The Web services module 132 may be enabled to process incoming Web service requests received via a push oriented service module, such as that provided by a WAP OTA module 134. The WAP OTA module 134 allows a session initiated at a server (e.g., a Push Proxy Gateway) to be established with the mobile phone 118B. This session can be used to invoke a procedure of the Web services module 132.

The functional components of the mobile phone 118B, including the Web services and WAP OTA modules 132, 134, may be implemented as firmware or as a program running on the OS 130. The Web services module 132 may use any combination of Web service protocols known in the art, including SOAP, XML-RPC, Universal Description, Discovery and Integration (UDDI), and Web Services Description Language (WSDL). Similarly, the WAP OTA module may utilize any combination of push protocols, such as WAP OTA connection-oriented (CO) push and the Push Application Protocol (PAP). Various transport protocols may be bound to push-initiated sessions, including HTTP and Wireless Session Protocol (WSP).

As referred to herein, the term “transport protocol” does not necessarily imply the transport layer as defined in models such as the Open System Interconnection (OSI) model. Typically, the term “transport protocol” as used herein refers to message-oriented protocols for transferring data in support of Web service transactions. These protocols typically operate at the application layer of the OSI model.

Web services invoked across the Internet are commonly bound to HTTP as the transport protocol, although Web services are generally not dependent on any one transport protocol. As previously described, Web services may be bound to WSP. WSP was developed as an integral part of the WAP architecture. WSP is designed to implement a request-response protocol for transferring data much like HTTP. However, WSP includes adaptations for use in mobile environments, such a byte-code syntax to reduce bandwidth and connection oriented sessions that allows retaining a server connection even when changing between base stations.

Generally, WAP defines a set of specifications and standards for developing applications that operate over wireless communication networks. The intention of a protocol such as WAP is to enable advanced services, differentiation, and fast/flexible service creation for wireless communications. WAP defines a set of protocols in the transport, session and application layers of the OSI networking model.

One part of the WAP specification defines the OTA protocol for delivery of content to a WAP client from a WAP server. This content delivery protocol is referred to as the Push OTA protocol. The Push OTA protocol Push OTA is a thin, stateless, application protocol layer that can be built on top of the WSP layer or the HTTP layer. Push OTA provides the ability to push contents to WAP clients, as well as related functionality such as facilitating server-initiated asynchronous pushes, application addressing, defining exchange of push control information over the air, facilitating bearer selection and controls, and determining the authentication of a push initiator.

The Push OTA protocol layer can provide WAP push support for either connectionless or connection-oriented mode. Connection-oriented push involves establishing a push session before the push content is to be delivered. Connection-oriented push may be confirmed or unconfirmed. The connectionless push can be performed using WSP connectionless session service primitives. Two well-known Wireless Datagram Protocol (WDP) ports are reserved in clients capable of connectionless push. One port is for a secure push and the other is for a non-secure push.

Establishing a push session generally requires that client devices support two-way bearer services. It may be possible, however, to pre-establish a push session between a client and a server so that connection-oriented unconfirmed and connectionless push might be conducted on a device with only one way bearer services.

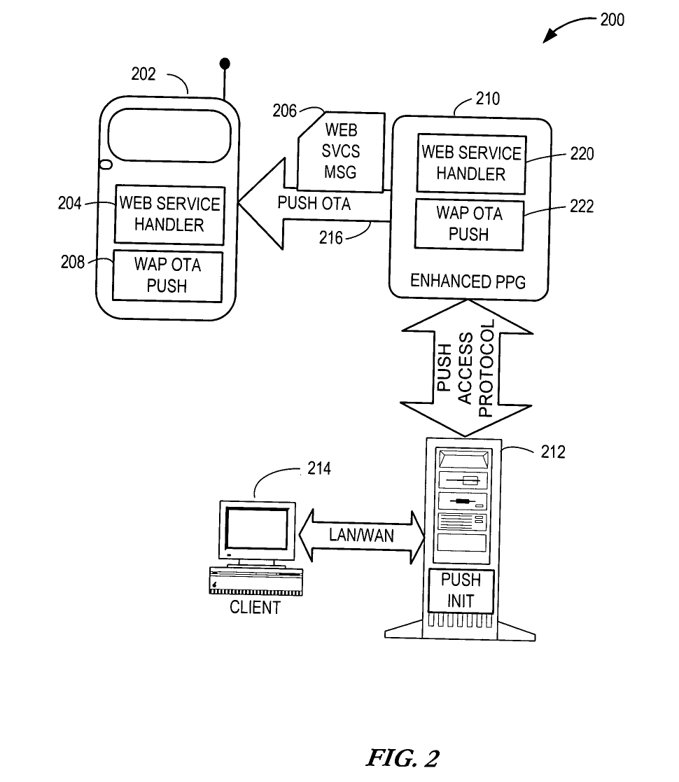

Turning now to FIG. 2, a Push OTA arrangement 200 is illustrated that may be adapted for Web services according to embodiments of the present invention. A mobile terminal 202 includes a Web services handler (e.g., SOAP handler) 204 that is configured to receive an incoming Web services message 206 (e.g., a SOAP message). The mobile terminal 202 includes a Push OTA handler 208 configured to handle server initiated data sessions. The Push OTA Handler 208 dispatches the SOAP envelope content of the incoming SOAP message 206 to the SOAP handler 204. Similarly, SOAP response messages can be sent from the SOAP handler 204 to the Push OTA Handler 208. The Push OTA Handler 208 then sends the response message back to the network and targeted for the originator of the SOAP message 206.

The Push OTA protocol allows clients to exchange data with wireless devices via an intermediary server called the Push Proxy Gateway (PPG) 210. The illustrated PPG 210 is enhanced with a Web services handler 220 and a WAP Push OTA handler 222 that can facilitate Web services sessions served from the mobile terminal 202. In the connection oriented mode of Push OTA, a connected session 216 is established between the mobile terminal 202 and the PPG 210 using an underlying transport layer. The connection-oriented Push OTA allows binding the session 216 to WSP and/or HTTP transport layers. Once the session is established, the push data is sent from the PPG 210 using this session 216.

The Push OTA mechanism provides a transparent way for Web services to be invoked on the mobile terminal 202. For this example, it will be assumed that the Web service handled by the mobile terminal 202 is a SOAP procedure. Invoking a SOAP procedure involves sending an XML formatted message from a client to a SOAP server. The SOAP server may respond to the SOAP procedure by sending a SOAP response message to the client. In the illustrated arrangement 200, the mobile terminal 202 is configured as a server to respond to an incoming SOAP message 206.

The SOAP message 206 may originate on any data processing arrangement, such as a push initiator 212 or a client machine 214 coupled to the arrangement 200 via a mechanism such as a Wide Area Network (WAN) or Local Area Network (LAN). The push initiator 212 is typically a server that generates and sends content to the PPG 210 using the Push Access Protocol (PAP). The push initiator 212 sends multi-part submissions to the PPG 210 that may include a control entity, a content entity, and a capabilities entity. The control entity may be formatted in XML and contain details of the delivery (for example, recipient, expiration time, network bearer, etc.). The push initiator 212 may originate the content, or it may forward the content from another connected machine such as the client 214.

SOAP messages sent over HTTP are typically addressed to Universal Resource Locators (URLs) that include a hostname or IP address of the SOAP HTTP server. If the URL contains an Internet hostname, the hostname can be resolved to an IP address using a Domain Name Server (DNS). IP addresses can be located using Internet routing protocols. However, the mobile terminal 202 acting as a SOAP server may not have an address that is routable using standard Internet protocols. Therefore, a SOAP message 206 destined for a mobile terminal 202 may require a specially formed URL. The specially formed URL may include an address of the PPG 210, or the address of any network entity arranged to work in concert with the PPG 210 in sending SOAP requests to mobile terminals. The URL may also include a network-specific OTA Push address of the terminal 202.

There are various ways of addressing a Web service (e.g., SOAP) message for a mobile terminal 202 using the terminal's OTA Push address. In one example, a URL may be formed using the address of the PPG 210 or other appropriate network entity and including a network specific OTA Push address as a query string. The query string can be processed using any manner of server side query handler. In another example, the OTA Push address may be included in protocol headers (e.g., HTTP headers) of requests that are sent to the PPG 210 or other network entity.

The PPG 210 may be configured to implement a server-side push of SOAP messages using the SOAP handler 220 and the OTA Push handler 222. In one example, the SOAP handler 220 implements a listener for incoming SOAP messages for all mobile terminals handled by the PPG 210. The listener may determine the destination mobile terminal by data embedded in the SOAP message or protocol headers. After identifying the target mobile terminal, the PPG 210 can send the request to the target using OTA Push and an HTTP or WSP binding.

When using an HTTP binding, the PPG 210 sets the “Wap-Push-Info” header attributer to include the “response” token, which indicates that a message body may be included in the response to the HTTP POST request. When using a WSP binding, the PPG 210 first creates a SOAP transaction that begins with an initial WAP OTA connection-oriented push using the SOAP envelope as contents.

For both HTTP and WSP bindings, the PPG 210 may be arranged to provide a standard SOAP interface, or to provide a specially adapted Web services interface to allow SOAP invocations using a server-initiated push. In an example of the first arrangement, the PPG 210 acts as a gateway for the standard HTTP-SOAP binding. In this arrangement, the PPG 210 translates SOAP requests to use the specified WAP OTA protocol binding mechanism, and translates SOAP responses to the standard SOAP-HTTP reply. In an example of the second arrangement, the PPG 210 may utilize an extension to the Push Application Protocol (PAP) to support SOAP invocation over PAP.

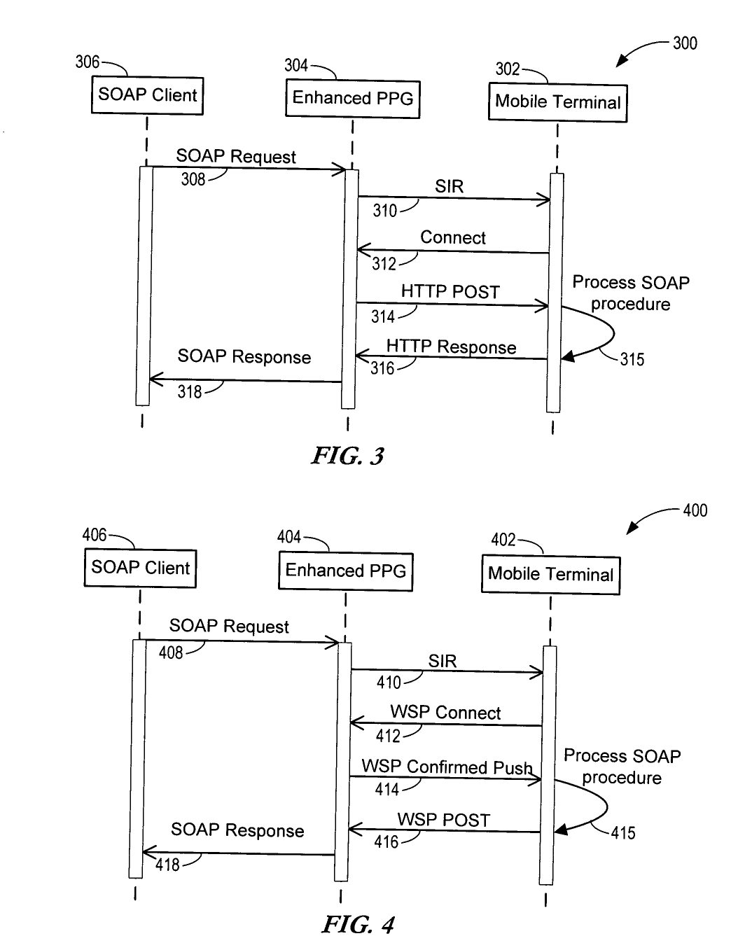

Turning now to FIG. 3, a sequence diagram 300 illustrates one example of binding SOAP to OTA Push using HTTP. In this diagram, a mobile terminal 302 is in communication with a PPG 304. A SOAP client 306 invokes a SOAP procedure targeted for the mobile terminal 302. This invocation may occur by sending a SOAP request 308 to the PPG 304 using a specially formatted message that indicates which OTA Push terminal the request is targeted for. The SOAP request 308 can be accomplished using the standard HTTP POST procedure. The SOAP request envelope is sent as the POST body.

After receiving the SOAP request 308, the PPG 304 sends a session initiation request (SIR) 310 to the mobile terminal 302 via a connectionless push. This SIR 310 requests the establishment of a session over the specified transport layer, HTTP in this example. The mobile terminal sends a connect response 312 to the PPG 304 to confirm establishment of the session. Once the session is established, the PPG 304 can send an HTTP POST 314 to the mobile terminal 302 to invoke the SOAP procedure. The mobile terminal 302 processes the SOAP procedure 315 and supplies an HTTP response 316 to the PPG 304. The PPG 304 responds in kind with a SOAP response 318 to the client 306.

A similar exchange may be used to implement SOAP over OTA CO Push using a WSP binding. In reference now to FIG. 4, a sequence diagram 400 includes a mobile terminal 402 in communication with a PPG 404. A SOAP client 406 invokes a SOAP procedure targeted for the mobile terminal 402 by sending a SOAP request 408 to the PPG 404. The PPG 404 sends a SIR 410 to the mobile terminal 402, and the mobile terminal responds with a WSP connect 412.

For a SOAP transaction using WSP binding as illustrated in FIG. 4, the OTA Push transaction alone may not be able to carry the SOAP request and response, since the OTA Push response cannot contain body data. One way to deal with this is to use a WSP connection-oriented confirmed push 414 containing the SOAP envelope as the push data. After the SOAP procedure is processed 415 by the mobile terminal 402, the SOAP response envelope is included as the data portion of a WSP POST request 416. The PPG 404 receives the SOAP response envelope from the body of the WSP POST request 416 and forms a SOAP response 418 and sends the response to the SOAP client 406.

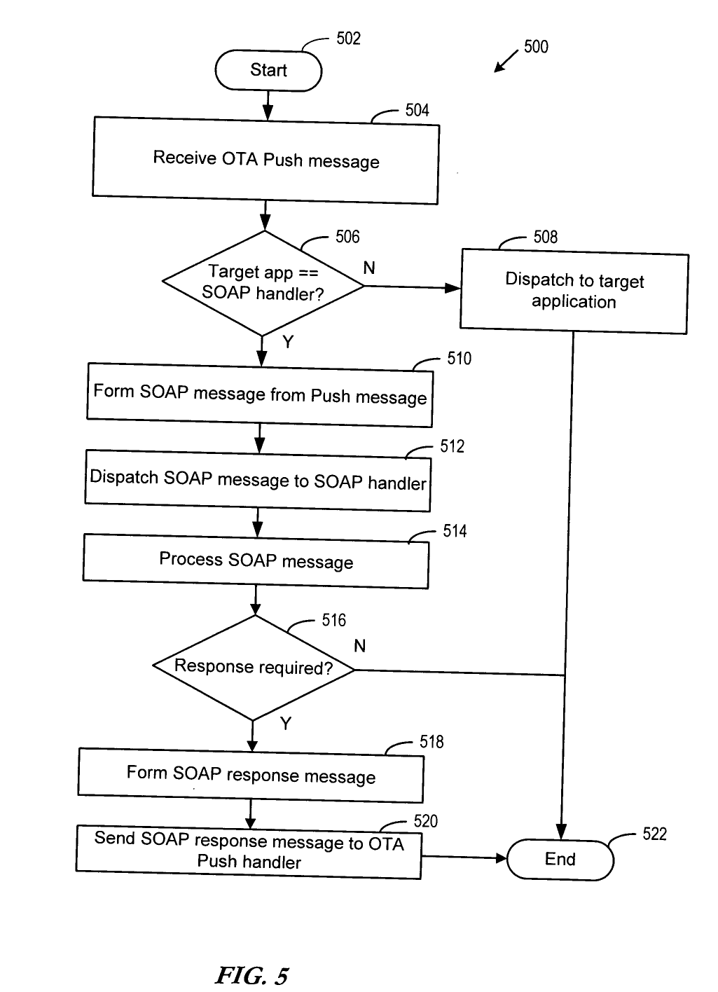

The handling of SOAP transactions over OTA Push at the various network entities may be handled by various functional modules within the entities. An example of how a mobile terminal might handle and incoming SOAP message over OTA Push is illustrated in the flowchart 500 of FIG. 5. The routine begins (502) with the OTA Push handler of the mobile terminal receiving (504) a push message. The push message may be received using various transport protocols, such as an HTTP POST or a WSP Confirmed Push. The mobile terminal determines (506) whether the target application for the push message is the SOAP handler.

There may be various ways of determining (506) whether the SOAP handler is the message's target application. The push message may include a push application identifier. The push application identifier can be used in directing the incoming push data to the appropriate handler application. A push application identifier can be assigned to the SOAP handler application, so that dispatching the message involves examining the identifier of the incoming message to see whether it matches the SOAP handler identifier. In other arrangements, the message application identifier may include the identifier of an existing application. This existing application can dispatch the message to the SOAP handler based on a header field such as “content-type”.

If the incoming push message is not meant for the SOAP handler, it can be dispatched (510) to the appropriate handler application by the usual mechanisms. If the incoming message is targeted for the SOAP handler application, then a SOAP message can be formed (512) from the message body. Forming (512) the SOAP message may involve at least stripping off lower-level protocol headers or other data. The SOAP message then dispatched (514) to the handler. If a response is required (516), then the SOAP handler can form (518) a SOAP response message. This SOAP response message can be sent (520) to the network via OTA Push handler, and the procedure is complete (522).

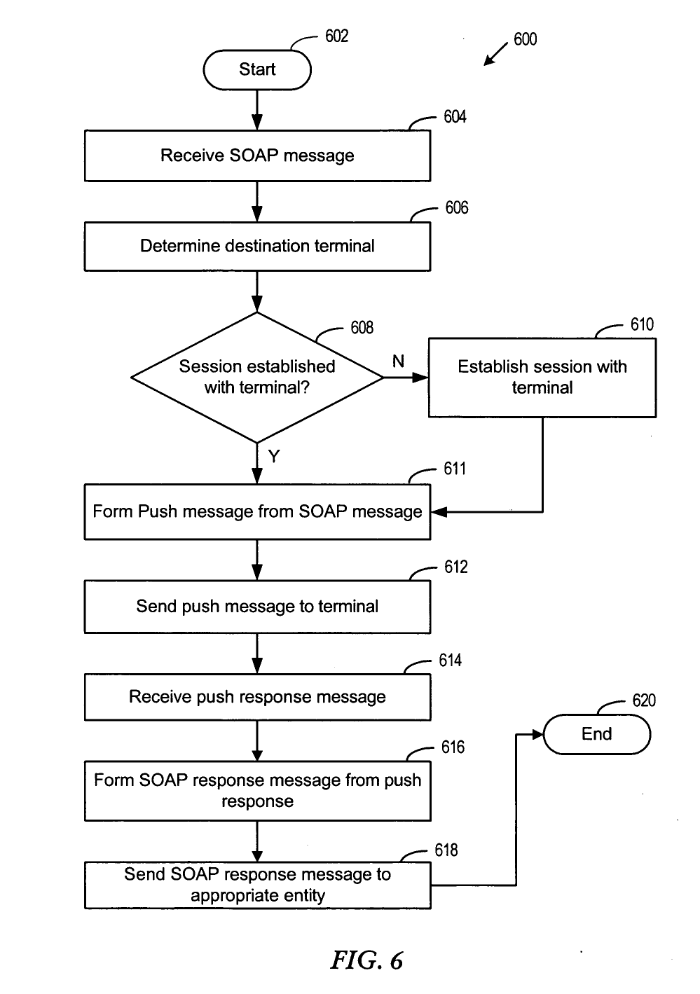

Referring now to FIG. 6, a flowchart 600 illustrates one procedure that may be used by a PPG and various other server entities in sending Web services (e.g., SOAP) messages over OTA Push to a mobile terminal according to embodiments of the present invention. The procedure begins (602) with the receiving (604) of a Web service message. The destination mobile terminal is determined (606) based on the SOAP message URL or other data in the message. If a push session has not been initiated (608) with the mobile terminal, the session is established (610) using a SIR or other suitable mechanism.

Once the session has been established (610), the PPG can form a push message (611) from the SOAP message and send the push message (612) to the mobile terminal. The sending (612) of the push message generally involves using a transport protocol and the appropriate procedure of that protocol, such as HTTP POST or WSP Confirmed Push. The push response message may be received (614) using an appropriate transport mechanism such as HTTP Response or WSP POST. A SOAP response message is formed (616) from the push message, and the SOAP response message is sent (618) to the appropriate entity, after which the routine is complete (620).

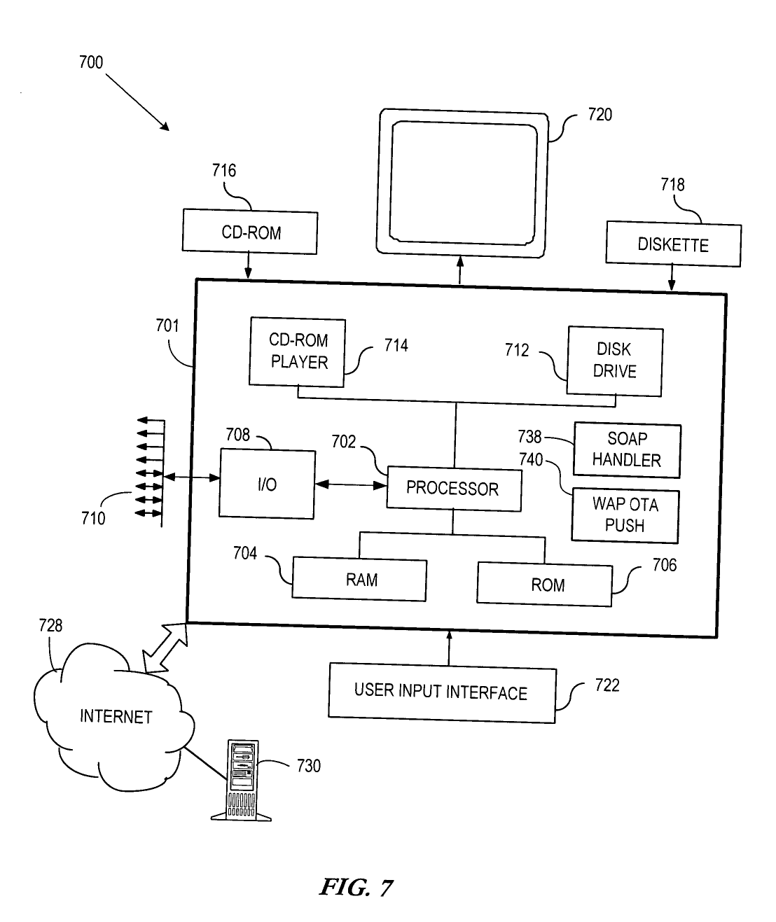

Turning now to FIG. 7, an example computing structure 700 is illustrated that is suitable for performing messaging activity in accordance with embodiments of the present invention. The computing structure 700 includes a computing arrangement 701. The computing arrangement 701 may act a server, client, gateway, proxy, or any other network entity used for processing data pushes to remote mobile clients for delivering Web service messages. The computing arrangement 701 includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, processing of SOAP messages, may be performed by the computing arrangement 701 at a SOAP handling module 738. The SOAP handling module 738 can communicate SOAP messages with a WAP OTA Push module 740. The WAP OTA Push module 740 can process server-initiated sessions for receiving incoming Web service requests.

External data storage devices, such as databases, may be coupled to I/O circuitry 708 to facilitate messaging functions according to the present invention. Alternatively, such databases may be locally stored in the storage/memory of the server 701, or otherwise accessible via a local network or networks having a more extensive reach such as the Internet 728. The processor 702 carries out a variety of functions as is known in the art, as dictated by software and/or firmware instructions.

The computing arrangement 701 may also include one or more data storage devices, including hard and floppy disk drives 712, CD-ROM drives 714, and other hardware capable of reading and/or storing information such as DVD, etc. In one embodiment, software for carrying out the messaging operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to computing arrangement 701 via data signals, such as being downloaded electronically via a network, such as the Internet 728. The computing arrangement 701 may be coupled to a display 720, which may be any type of known display or presentation screen, such as LCD displays, plasma display, cathode ray tubes (CRT), etc. A user-input interface 722 may be provided, including one or more user interface mechanisms such as a mouse, keyboard, microphone, touch pad, touch screen, voice-recognition system, etc.

The computing arrangement 701 may be coupled to other computing devices (e.g., a server 730), such as landline and/or wireless terminals via a network, for Web service messaging. The server 730 may be part of a larger network configuration as in a global area network (GAN) such as the Internet 728, which allows connections to the various landline and/or mobile devices.

Providing Web services from mobile devices may be advantageous in many applications. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the message functionality as described herein. Hardware, firmware, software or a combination thereof may be used to perform the various Web service messaging functions described herein.

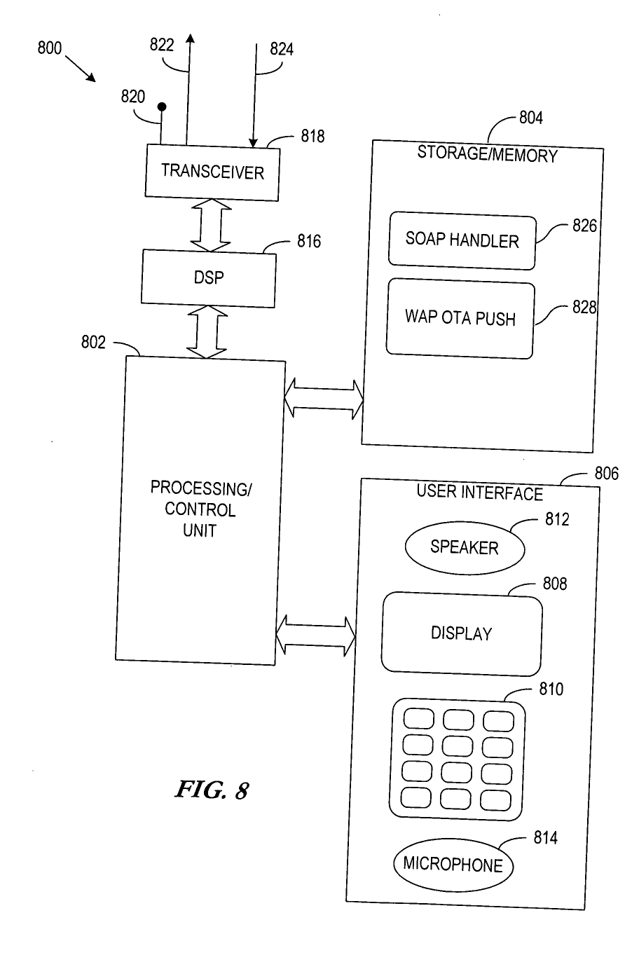

An example of a representative mobile terminal computing system capable of carrying out operations in accordance with embodiments of the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The mobile computing arrangement 800 is suitable for providing Web service communications using a wireless push protocol in accordance with embodiments of the present invention. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by the SOAP messaging module 826 and OTA Push module 828 available in the program storage/memory 804. Thus, the processing unit 802 may be capable of sending and receiving messages using the SOAP messaging module 826 in conjunction with the OTA Push module 828. The OTA Push module 828 may be arranged to exchange messages with a PPG or other network entity and communicate these messages with the SOAP messaging module 826.

The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc.

Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a messaging system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method comprising:
forming a Web service message at a first network entity, the Web service message targeted for a second network entity;
establishing a Wireless Application Protocol (WAP) Connection-Oriented (CO) Over-The-Air (OTA) push session with the second network entity;
binding a transport protocol with the WAP CO OTA push session;
sending the Web service message to the second network entity via the WAP CO OTA push session using the transport protocol; and
processing the Web service message at the second network entity.

2. The method according to claim 1, wherein the Web service message includes a Simple Object Access Protocol (SOAP) message.

3. The method according to claim 1, wherein the transport protocol includes Hypertext Transport Protocol (HTTP).

4. The method according to claim 1, wherein the transport protocol includes Wireless Session Protocol (WSP).

5. The method according to claim 1, wherein processing the Web service message at the second network entity comprises forming a Web service response message targeted for the first network entity.

6. The method according to claim 5, further comprising sending the Web service response message targeted for the first network entity via the WAP CO OTA push session using the transport protocol.

7. A system for providing Web services from a mobile terminal, comprising:
means for receiving a Web service request message via a network;
means for transmitting the Web service request message via a Wireless Application Protocol (WAP) Connection-Oriented (CO) Over-The-Air (OTA) push session;
means for receiving the Web service request message at the mobile terminal via the WAP CO OTA push session; and
means for processing the Web service request message at the mobile terminal.

8. The system according to claim 7, wherein the Web service message includes a Simple Object Access Protocol (SOAP)message.

9. The system according to claim 7, further comprising means for binding the WAP CO OTA push session with Hypertext Transport Protocol (HTTP).

10. The system according to claim 7, further comprising means for binding the WAP CO OTA push session with Wireless Session Protocol (WSP).

11. The system according to claim 7, further comprising:
means for forming a Web service response message at the mobile terminal in response to the Web service request message; and
means for transmitting the Web service response message from the mobile terminal via the server initiated wireless push session.

12. A mobile terminal wirelessly coupled to a network, comprising:
a transceiver configured to facilitate exchange of data with the network via a Wireless Application Protocol (WAP) Connection-Oriented (CO) Over-The-Air (OTA) push session;
a memory capable of storing at least one of a data transfer module and a Web services processing module; and
a processor coupled to the memory and the transceiver, the processor configured by the data transfer module to receive Web service messages targeted for the mobile terminal via the WAP CO OTA push session and communicate the Web service messages to the Web services processing module, the processor configured by the Web services processing module to process the Web service messages.

13. The mobile terminal according to claim 12, wherein the Web service messages include Simple Object Access Protocol (SOAP)messages.

14. The mobile terminal according to claim 12, wherein the processor configured by the data transfer module to bind the WAP CO OTA push session with Hypertext Transport Protocol (HTTP) for receiving the Web service messages.

15. The mobile terminal according to claim 12, wherein the processor configured by the data transfer module to bind the WAP CO OTA push session with Wireless Session Protocol (WSP) for receiving the Web service messages.

16. A computer-readable medium having instructions stored thereon which are executable for providing Web services on a mobile terminal by performing steps comprising:
establishing a Wireless Application Protocol (WAP) Connection-Oriented (CO) Over-The-Air (OTA) push session with a network entity via a wireless network;
binding a transport protocol with the WAP CO OTA push session;
receiving a Web service message from the network entity via the WAP CO OTA push session using the transport protocol; and
processing the Web service message.

17. The computer readable medium according to claim 16, wherein the Web service message includes a Simple Object Access Protocol (SOAP)message.

18. The computer readable medium according to claim 16, wherein the transport protocol includes Hypertext Transport Protocol (HTTP).

19. The computer readable medium according to claim 16, wherein the transport protocol includes Wireless Session Protocol (WSP).

20. The computer readable medium according to claim 17, wherein the steps further comprise:
forming a Web service response message based on the Web service message; and
sending the Web service response message to the second network entity via the server-initiated wireless push session.

21. A server coupled to a network and used to facilitate communications with a wireless terminal, comprising:
means for receiving a Web service message targeted for the wireless terminal via the network;
means for initiating a Wireless Application Protocol (WAP) Connection-Oriented (CO) Over-The-Air (OTA) push session with the wireless terminal; and
means for sending the Web service message to the wireless terminals via the WAP CO OTA push session.

22. The server according to claim 21, wherein the Web service message includes a Simple Object Access Protocol (SOAP) message.

23. The server according to claim 21, further comprising means for binding the WAP CO OTA push session with Hypertext Transport Protocol (HTTP) for receiving the Web service message.

24. The server according to claim 21, further comprising means for binding the WAP CO OTA push session with Wireless Session Protocol (WSP) for receiving the Web service message.

25. The server according to claim 21, further comprising:
means for receiving a Web service response message from the wireless terminal via the server-initiated push session; and
means for communicating the Web service response messages to an originator of the Web service message via the network.
